(19) United States
(12) Patent Application Publication
(10) Pub. No.: US 2013/0132738 A1
(43) Pub. Date: May 23, 2013

(54) Externally Powered System Access

(71) Applicants: Kulvir Singh Bhogal, Pflugerville, TX (US); Rick Allen Hamilton, II, Charlottesville, VA (US); Andrew R. Jones, Round Rock, TX (US); Brian Marshall O'Connell, RTP, NC (US)

(72) Inventors: Kulvir Singh Bhogal, Pflugerville, TX (US); Rick Allen Hamilton, II, Charlottesville, VA (US); Andrew R. Jones, Round Rock, TX (US); Brian Marshall O'Connell, RTP, NC (US)

(73) Assignee: INTERNATIONAL BUSINESS MACHINES CORPORATION, Armonk, NY (US)

(21) Appl. No.: 13/302,625

(22) Filed: Nov. 22, 2011

(51) Int. Cl. G06F 1/26; G06F 12/14; G06F 1/32

(52) U.S. Cl. 713/193; 713/300; 713/324

(57) ABSTRACT

A method, programmed medium and system are provided for an enhanced interface connection for a primary electronic device such that system storage devices (e.g. hard drives, solid state drives, flash drives, etc.) within the primary device may be made available to other nearby devices in the event of a power supply failure or battery failure or to preserve-battery power in the primary system whereby the data on a storage device within a primary system becomes accessible by external devices, without necessitating the removal of the storage medium or full powering-up of the primary system.

### FIELD OF THE INVENTION

The present invention relates generally to information processing systems and more particularly to a methodology and implementation for enabling external access to powered-down storage devices.

### BACKGROUND OF THE INVENTION

The Universal Serial Bus (USB) is a standard connector for peripheral devices connected to computer systems. USB was intended to make it fundamentally easier to connect external devices to personal computers (PCs) by replacing the multitude of connectors at the back of PCs, addressing the usability issues of existing interfaces, and simplifying software configuration of all devices connected to USB, as well as permitting greater bandwidths for external devices.

A USB system has an asymmetric design, consisting of a host, a multitude of downstream USB ports, and multiple peripheral devices connected in a tiered-star topology. Additional USB hubs may be included in the tiers, allowing branching into a tree structure with up to five tier levels. A USB host may have multiple host controllers and each host controller may provide one or more USB ports.

In currently available PC systems, if a laptop computer or other computerized system runs out of battery power and a power supply is not available, there are no easy methods to access the hard drive of the power-deprived or un-powered computer. As used herein, the terms “hard drive” or “drive” include solid state drives as well. Presently, the only known solution is to physically remove the drive from the laptop.

Further, there is no current solution for accessing data stored in a storage system within an electronic device that is in a powered-down state without fully powering-up the electronic device.

Thus, there is a need for a method or system by which a power-deprived or powered-down computer may be accessed in-situ by an external device, in order to have access to, inter alia, data stored in the computer's storage system.

### SUMMARY OF THE INVENTION

A method, programmed medium and system are provided for an enhanced interface connection for a primary electronic device such that system storage devices (e.g. hard drives, solid state drives, flash drives, etc.) within the primary device may be made available to other nearby devices in the event of a power supply failure or battery failure or merely to preserve battery power in the primary system whereby the data on a storage device within a primary system becomes accessible by external devices, without necessitating the removal of the storage medium or full powering-up of the primary system.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one exemplary embodiment of a system in which the present invention may be implemented;

FIG. 2 is a block diagram showing several of the major components of an exemplary computer system or device using the present invention; and

FIG. 3 is a flow chart illustrating an exemplary operational sequence in one implementation of the present system.

### DETAILED DESCRIPTION

The various methods discussed herein may be implemented within a computer system which includes one or more processing systems, memory, storage means, input means and display means. Since the individual components of a computer system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present is invention and in order not to obfuscate or distract from the teachings of the present invention. Although the invention is illustrated in the context of a laptop computer, it is understood that the present invention may be implemented with any electronic device which contains a storage system of any kind including but not limited to hard drives and/or flash drive systems as may be contained in laptop computers, and hand-held electronic devices such as cell phones and other personal wireless systems which may also include any of many available input devices such as keyboards, keypads, pointing devices, touch-sensitive screens or touch-sensitive input pads, to achieve the beneficial functional features described herein. As used herein, the term “hard drive” refers to any storage system including but not limited to hard drives and/or solid-state or flash drive storage units.

Although USB is the predominant interface technology described in this disclosure, it is noted that the method and system described here can be extended to derivative or similar interface technologies, without loss of function or value. For example, although laptops and USB systems are detailed in this disclosure, the same principles may be applied to other mobile devices, e.g. telephones, so long as they have a sufficient interface mechanism and memory store (either hard drive or solid state) which can be accessed with power inputs.

The exemplary system disclosed herein enables owners of mobile devices to access data on their hard drive when their laptop is in a powered-down state. As used herein, the term “powered-down” includes system that are not fully powered, and includes systems states such as “OFF”, “Sleep”, “Hibernate”, etc. The disclosed system enables a second laptop, desktop, or other powered-up computing device to access the hard drive through a special bi-directional USB port. This port operates as a normal USB port when the laptop is powered, however, when the laptop is off or does not have full power, the USB port is modified to pass through to a USB hard drive controller attached to the laptop's (or other device) hard drive (or solid state storage). The system enables access to a device's internal hard drive(s) without removing the hard drive from the device when the device is without a power source (direct power or battery) or merely in a powered-down state.

The main embodiment includes a new USB port on a laptop (or other electronic/computing device). A Type B USB port and associated controller allows a laptop (or other device) to act as a typical USB hard drive. The USB host controller would provide access to a USB logical device which interfaces with a hard disk controller (e.g. SATA, IDE, solid state drives, etc.) to allow for the power up and access to the laptop's solid state drive(s).

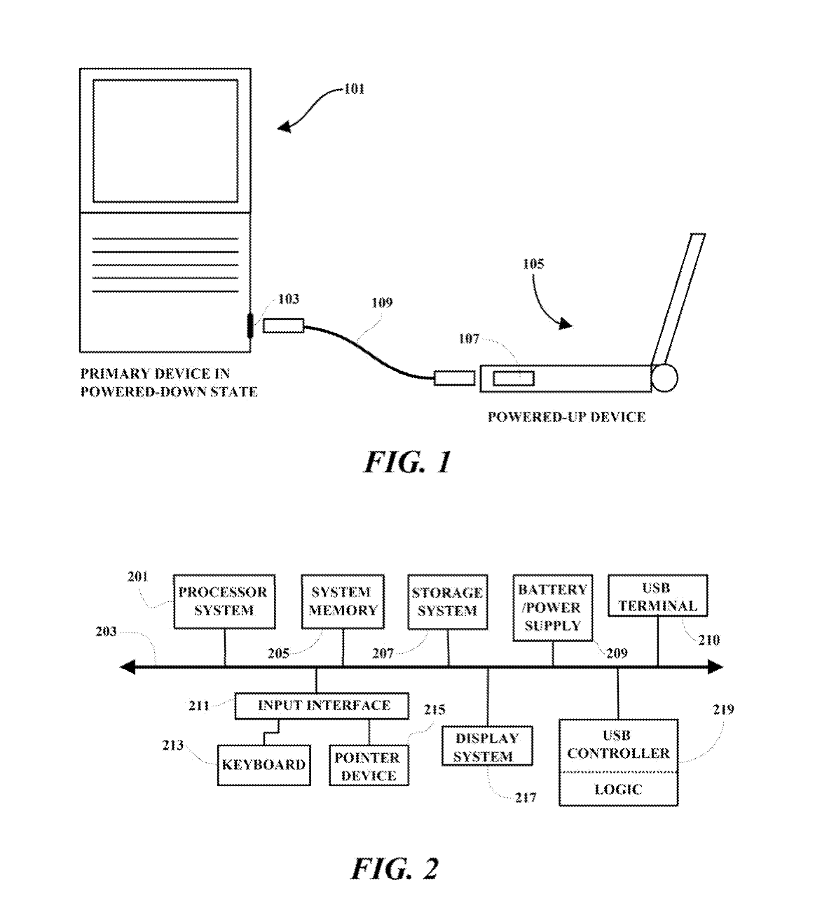

In the drawings, FIG. 1 illustrates an exemplary environment in which the present invention may be implemented. As shown, a laptop computer 101 includes a USB terminal 103. In the example, the laptop computer 101 is referred to as being a “primary” or “first” device and is shown as being in a “powered-down” state, i.e. the laptop 101 is OFF and not connected to a power source and the internal battery is depleted and not providing power, or the laptop is in a than fully-powered state such as being in a “sleep” or “hibernate” state. Also shown in the FIG. 1 illustration is a second laptop computer 105 which also contains a USB terminal 107. The second computer 105 is “powered-up”, i.e. it is either connected to a source of power such as an AC outlet or a charged internal battery. Although in the FIG. 1 illustration, both computers 101 and 105 are laptop computers, it is noted that either or both of these devices may be any electronic device having a storage system, including but not limited to personal electronic information storage and/or communication devices, wireless phones, printers, tablet computers and other systems, etc.

In an exemplary application, a USB cable connector 109 connects the powered device 105 to the powered-down primary device 101 in order for the powered device 105 to provide power to the primary device 101 and enable access to the storage system of device 101. In a specific example, an external device 105 is connected to the laptop 101 via the USB connector 109 and can access the primary laptop's internal hard drive(s) and/or solid state drives. The external device 105 provides power to enable access to the laptop's internal hard drive(s) and/or solid state drives via the USB connection 109.

The USB port described by this disclosure is enhanced from a traditional USB in that it can both output power, and receive power. It can route received power to specific devices and/or controllers. Bi-directionality may be controlled either by physical switch, electronic detection, software, etc. with logic, such as if laptop is powered on, disable access via USB port so not to interrupt the laptop's normal operation. Multiple methods may be used to switch the USB port from input to output. A physical switch may be provided on the outside of the laptop. One setting of the switch places the USB port in normal mode, the other setting places the USB port in storage-access mode. A Power Controlled Switch may also be used such that when the laptop is powered on, power is applied to a soft-switch that places the USB port in normal mode. If the laptop is not powered on, or the laptop is in a powered-down state, the lack of power applied to the soft-switch places it in its default mode of storage access. In another embodiment, a BIOS-Controlled Switch is provided and the BIOS has a setting that switches the USB port from normal to storage-access mode. This BIOS control may be accessed by software as well. Such a feature may be utilized by an operating system when shutting down due to lack of power, to switch access modes.

The disclosed system also provides for disabling the USB port or access described via either a physical switch, logical switch (e.g. accessed via software or the system BIOS) and the ability to enable/disable via above methods in systems using password and/or encryption access techniques.

FIG. 2 illustrates several of the major components of a computer system which may be used in the illustrated example. As shown, a processor system 201 is connected to a main bus 203. The main bus 203 is also coupled to, inter alia, system memory 205, a local storage system 207, and means 209 arranged for connection to a power supply such as an AC source or an internal battery. The computer system also includes a USB terminal 210 and an input interface 211 which, in the example, is connected to a keyboard or keypad 213 and a pointer device 215 such as a mouse. As noted earlier, the input interface 211 may also be connected to any other type of input including but not limited to touch-sensitive screens in a tablet computer system. The main bus 203 is also connected to a display system 217 and to a USB controller 219 including controller logic. Additional devices and bus systems, which are not shown, may also be coupled to the system main bus 203.

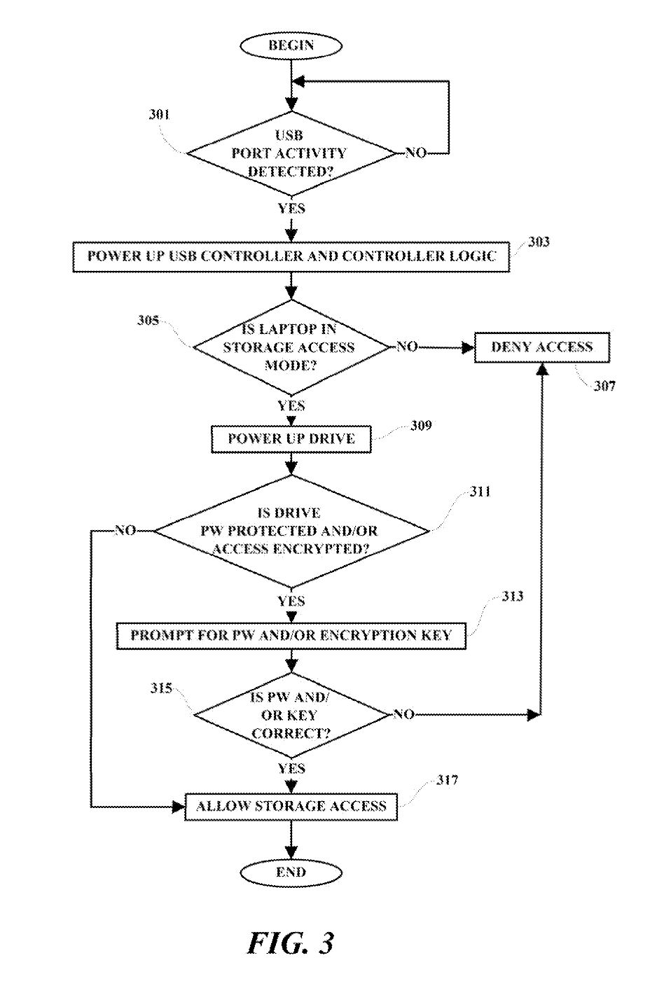

In FIG. 3, there is shown a flow chart illustrating an operational sequence in an exemplary implementation of the present system. A high level flow diagram is illustrated and demonstrates the process of a USB access to laptop 101 via external device 105, the powering of the USB Controller 219 via the USB connection 109, and a check if the laptop is operating in a normal operation to determine if access should be allowed or denied. An additional step is shown where logic is added to the controller 219 to determine whether or not the drive in laptop 101 is encrypted or password protected. If it is, then access is allowed if encryption key or password is verified, and access is denied if the password or encryption key provided is incorrect.

As shown in FIG. 3, when USB activity or a USB connection is detected 301 at terminal 103 of device 101, the USB controller 219 and controller logic is powered-up 303. Next, if the laptop 101 is not in a storage-access mode 305, access is denied 307. Next, if the laptop 101 is in a storage access mode, i.e. in a powered-down state, then the hard drive 207 of the laptop 101 is powered up 309 through the USB terminal 103 from the powered-up device 105. In situations where the drive is access protected by password or encrypted 311, the system prompts for a password and/or an encryption key 313 and if the password or encryption key input is correct 315, access is granted 317, otherwise, access is denied 307.

It is understood that the flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is further understood that the specific example presented herein is not intended to be limiting since the functional combinations disclosed herein may be implemented in many different environments and applications. The method, system and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in a program product including program code stored in any media/including any portable or fixed, volatile or non-volatile memory media device, including CDs, RAM and “Flash” memory, or other semiconductor, optical, magnetic or other memory media capable of storing code, from which it may be loaded and/or transmitted and/or transcribed into other media and executed to achieve the beneficial results as described herein. The disclosed methodology may also be implemented using any available input and/or display systems including touch-sensitive screens and input pads. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for providing power to a first electronic device, said first electronic device including a data terminal arranged for receiving and sending data and commands to and from said first electronic device, said method comprising:
detecting when a connecting cable is connected to said data terminal from a second electronic device;
after said detecting, enabling connection between said first electronic device and said second electronic device through said data terminal for applying power to said first electronic device from said second electronic device through said data terminal if said first electronic device is detected to be in a powered-down state; and
disabling said power connection between said first electronic device and said second electronic device if said first electronic device is detected not to be in a powered-down state.

2. The method as set forth in claim 1 wherein said data terminal is a USB terminal.

3. The method as set forth in claim 2 wherein said connecting cable includes a USB terminal at each end thereof.

4. The method as set forth in claim 2 wherein said method further includes:
applying power received by said first electronic device from said second electronic device to a storage system within said first electronic device; and
accessing data contained in said storage system through said data terminal of said first electronic device.

5. (canceled)

6. The method as set forth in claim 4 and further including
determining if said storage system is password protected and/or access encrypted;
if said storage system is password protected and/or access encrypted, enabling an input of a password and/or encryption key; and
allowing access to said storage system only if said password and/or encryption key input is correct.

7. The method as set forth in claim 2 and further including:
switching said USB terminal between a normal mode and a storage system access mode.

8. The method as set forth in claim 7 and further including maintaining said USB terminal in a normal mode when said first electronic device is powered-up, and switching said USB terminal to said storage system access mode when said first electronic device is in a powered-down state.

9. The method as set forth in claim 8 wherein said mode switching is BIOS-controlled.

10. The method as set forth in claim 8 wherein said mode switching is controlled by an operating system shut-down process following a detection by said operating system of an absence of power.

11. A computer program product comprising a computer-readable, tangible storage device(s) and computer-readable program instructions stored on the computer-readable, tangible storage device(s) for enabling a first electronic device to receive power from a second electronic device, said first electronic device including a data terminal arranged for receiving and sending data and commands to and from said first electronic device, the computer-readable program instructions, when executed by a processing system, being operable for implementing a method comprising:
detecting when a connecting cable is connected to said data terminal from said second electronic device;
after said detecting, enabling a power connection between said first electronic device and said second electronic device through said data terminal for applying power to said first electronic device from said second electronic device through said data terminal if said first electronic device is detected to be in a powered-down state; and
disabling said power connection between said first electronic device and said second electronic device if said first electronic device is detected not to be in a powered-down state.

12. The computer program product as set forth in claim 11 wherein said data terminal is a USB terminal.

13. The computer program product as set forth in claim 12 wherein said method further includes:
applying power received by said first electronic device from said second electronic device to a storage system within said first electronic device; and
accessing data contained in said storage system through said data terminal of said first electronic device.

14. (canceled)

15. The computer program product as set forth in claim 13 wherein said method further includes:
determining if said storage system is password protected and/or access encrypted;
if said storage system is password protected and/or access encrypted, enabling an input of a password and/or encryption key; and
allowing access to said storage system only if said password and/or encryption key input is correct.

16. The computer program product as set forth in claim 12 wherein said method further includes:
providing a mode switching function for said first electronic device, said mode switching function being selectively operable for switching said USB terminal between a normal mode and a storage system access mode.

17. The computer program product as set forth in claim 16 wherein said mode switching function is operable for maintaining said USB terminal in a normal mode when said first electronic device is powered-up, said mode switching function being further operable for switching said USB terminal to said storage system access mode when said first electronic device is in an un-powered state.

18. The computer program product as set forth in claim 17 wherein said mode switching device is BIOS-controlled.

19. The computer program product as set forth in claim 17 wherein said mode switching function is controlled by an operating system shut-down process following a detection by said operating system of an absence of power.

20. A system for providing power to a first electronic device, said first electronic device including a data terminal arranged for receiving and sending data and commands to and from said first electronic device, said system comprising:
a detection device for detecting when a connecting cable is connected to said data terminal from a second electronic device; and
a controller device coupled to said detection device, said controller device being operable in response to a detected connection to said connecting cable for enabling a power connection between said first electronic device and said second electronic device through said data terminal for applying power to said first electronic device from said second electronic device through said data terminal if said first electronic device is detected to be in a powered-down state; and
disabling said power connection between said first electronic device and said second electronic device if said first electronic device is detected not to be in a powered-down state.
